(19) United States
(12) Patent Application Publication
(10) Pub. No.: US 2017/0059048 A1
(43) Pub. Date: Mar. 2, 2017

(54) Rotatable Pressure Relief Valve Assembly

(71) Applicant: BS&B INNOVATION LIMITED, Limerick (IE)

(72) Inventors: Geoffrey BRAZIER, Woodbury, MN (US); John TOMASKO, Limerick (IE)

(73) Assignee: BS&B INNOVATION LIMITED, Limerick (IE)

(21) Appl. No.: 15/119,786

(22) PCT Filed: Feb. 20, 2015
(86) PCT No.: PCT/US2015/016904

§ 371 Date: Aug. 18, 2016

Related U.S. Application Data
(60) Provisional application No. 61/966,335, filed on Feb. 21, 2014.

(51) Int. Cl. F16K 17/02; F16K 17/40; F16K 17/14; F16K 17/12; F16K 47/02; F16K 1/18

(52) U.S. Cl. CPC F16K 17/025; F16K 47/023; F16K 1/18; F16K 17/14; F16K 17/12; F16K 17/406

(57) ABSTRACT

A rotatable pressure relief valve assembly is disclosed. The rotatable pressure relief valve assembly may comprise a rotatable plug mounted within a valve body, along with a release mechanism configured to engage with the shaft and hold the plug in a closed position until an opening pressure of the valve assembly is reached. An assembly may include a damper configured to absorb a rotational kinetic energy or a catching mechanism configured to retain the plug in an open position when the plug rotates into the open position. A plug may be wing-shaped or have a mass balanced across a rotatable shaft offset from a diameter of the plug. An assembly may include a buckling pin, torque pin, tensile member or other release mechanism, which may be pre-loaded. A thermal shield also may be provided.

### FIELD

The present disclosure relates to a rotatable valve assembly for relieving pressure from a pressurized system. More particularly, the disclosure relates to a rotatable valve assembly, or an associated component of a rotatable valve assembly, with improved flow characteristics.

### BACKGROUND

There are many types of systems that process or use a pressurized fluid. To ensure the safety of these types of systems, each such system typically includes a safety device designed to prevent the over-pressurization of the system. In an emergency situation, where the fluid in the system reaches an unsafe level or pressure, the high pressure of the fluid acts on the safety device to create an opening to release fluid from the system. Venting fluid to the environment or a safety reservoir through the opening reduces the pressure in the system and prevents another portion of the system from failing due to the high pressure of the fluid.

One type of safety device for a pressurized system is a pressure relief valve, which may be a reclosing valve or a non-reclosing valve. Typically, a spring, a pin, or a combination of a spring and pin, is used to hold a moving plug or disc in sealing engagement with the body or housing of the device while connected to the pressurized system. When the pressure of the fluid reaches the predetermined safety level in such systems, the force exerted on the plug by the pressurized fluid overcomes the bias of the spring or exceeds the resistance of the pin that holds the plug in place. When either of these events occurs, the pressurized fluid moves the plug to expose an opening through which fluid may escape to relieve the pressure in the system.

One type of pressure relief valve is a rotatable valve assembly. Known rotatable valve assemblies are disclosed in commonly owned U.S. Pat. Nos. 5,607,140, 5,947,445, 5,984,269, 6,098,495, 6,367,498, 6,488,044, and 6,491,055, the entire contents of each of which are expressly incorporated herein by reference. A rotatable valve includes a plug that is mounted on a rotatable shaft and may be rotated between a closed position where the plug blocks the flow of fluid and an open position where the plug allows fluid to flow through the valve. In the closed position, the plug face is oriented toward the pressurized system. While in the open position, the plug face is oriented substantially parallel to the flow of the fluid being relieved. The rotation of the plug to the open position may be initiated manually or by another external force. Alternatively, the plug may be mounted on the shaft so that the rotational axis of the plug is offset relative to the center of the plug, so that the pressurized fluid exerts a torque on the shaft and urges the plug to rotate. A device may be coupled to the shaft to prevent the shaft from rotating until the torque on the shaft reaches a certain level, indicating that the pressure of the fluid has reached an over-pressure situation. At that point, the shaft is released and the plug rotates to open the valve and vent the system.

When the rotatable valve assembly opens, it may be desirable to maximize the rate of fluid flow through the open valve. Factors impacting flow rate include flow area and flow turbulence.

Typically, the flow area is maximized when the valve plug face is substantially parallel to the direction of fluid flow—i.e., when the plug is in a “fully open” orientation. In some cases, however, the plug may open with a high rotational velocity that may cause the plug to rotate beyond a fully open orientation (thereby partially closing off the fluid flow path) and/or cause the plug to oscillate or “bounce” between fully-open and partially-closed orientation as the relieved fluid escapes from the system. In such a case, the flow path of a relieved fluid may be obstructed, thereby diminishing the flow rate or adding undesirable agitation to the fluid flow, which may lead to damage to moving parts of the valve itself. Accordingly, there is a need for a valve plug assembly including one or more features to hold the valve plug in an open position, absorb rotational energy of an opening valve plug, and/or reduce the capacity of the valve plug to oscillate between fully-open and partially-closed orientations.

Even when a typical valve plug is in a substantially open position, turbulence in the flow of a relieved fluid may diminish the valve's performance. Typically, an open valve plug exhibits an angular shape or abrupt contours, which may tend to increase flow turbulence, potentially leading to damage to valve flow capacity and valve construction. Accordingly, there is a need for a valve plug shaped to reduce the turbulence of an escaping fluid.

Many rotatable valve assemblies are used in applications where a great deal of heat, including radiant heat from processes, is generated in the environment. High temperatures may adversely affect the performance of a rotatable valve assembly. For example, high temperatures may cause valve components to warp and negatively impact the valve's operation. High temperatures may, for example, distort the shape of the valve plug or valve body relative to the valve's rotational shaft in a manner that may interfere with the valve's ability to open. As another example, high temperatures may impact the performance of valve plug seals, valve plug lubricants, release mechanisms (e.g., pins) or other components that the valve relies on to ensure optimal performance. Typically, heat shielding is used only to protect controls and similar components from heat. There is a need for a mechanism to protect a rotatable valve assembly (or components thereof) from environmental heat as well.

In a rotatable valve plug provided with a rotational axis offset from the center of the plug, the mass of the valve plug is unevenly divided across the rotational axis. That imbalance may impact the valve plug's ability to rotate, and may impact the pressure level at which the valve plug may open. In addition, such imbalance may amplify the oscillation of the valve in the flow path, which may reduce flow capacity and may damage the valve components. There is a need for an offset. type valve plug that is designed to be weight-balanced or gravity-neutral relative to the rotational axis. Such a plug may provide more predictable valve performance, because the number of factors impacting opening pressure and flowing position of the valve may be reduced.

As noted above, a device (e.g., a release mechanism) may be provided to prevent a rotatable valve plug assembly from opening until a predetermined pressure differential is reached. Such a release mechanism may include, for example, a deformable or frangible failure mechanism, such as a buckling pin, designed to deform or break in response to a predetermined load, Known valves rely on the pressure differential across the valve to generate all of the opening torque. This requires that the torque required to close the valve be kept sufficiently small so as not to influence the torque required to open the valve. It may be desirable to pre-load a release mechanism to add to the opening torque. Such pre loading may reduce the impact of plug inertia, static friction (e.g., in valve seals and mechanical linkages), and closing torques on the speed at which a valve plug may open. It may further be desirable to pre-load release mechanisms other than buckling pins, such as shear pins or pins or plates designed to fail in tension.

This disclosure may overcome one or more of the deficiencies above, may provide one or more of the desired advantages above, may overcome other deficiencies in the art, and/or may provide additional benefits.

### SUMMARY

To overcome one or more of the deficiencies above, provide one or more of the desired advantages above, or to overcome other deficiencies and/or provide other benefits, as embodied and described herein, the disclosure is directed to a rotatable pressure relief valve assembly, comprising a valve body and a plug mounted within the body, the plug being rotatable between an open position and a closed position about a rotatable shaft. A release mechanism may be configured to engage with the shaft and hold the plug in a closed position until an opening pressure of the valve assembly is reached, and a damper may be configured to absorb a rotational kinetic energy imparted by the shaft when the valve plug rotates into the open position.

The disclosure is further directed to a rotatable pressure relief valve assembly, comprising a valve body and a plug mounted within the body, the plug being rotatable between an open position and a closed position about a rotatable shaft. A release mechanism may be configured to engage with the shaft and hold the plug in a closed position until an opening pressure of the valve assembly is reached, and a catching mechanism may be configured to engage shaft when the valve plug rotates into the open position, wherein the catching mechanism may be further configured to retain the plug in the open position.

The disclosure also is directed to a rotatable pressure relief valve assembly, comprising a valve body and a plug mounted within the body, the plug being rotatable between an open position and a closed position about a rotatable shaft, wherein the plug is wing-shaped.

Also disclosed is a rotatable pressure relief valve assembly, comprising a valve body, a valve shaft, and a plug engaged with the valve shaft and disposed within the valve body, wherein the plug has a diameter parallel to the shaft, and wherein the diameter is offset from the shaft, and wherein the mass of the plug is balanced across the shaft.

Further disclosed is a rotatable pressure relief valve assembly, comprising a valve body and a valve plug disposed within the valve body, the valve plug having a shaft defining an axis of rotation, wherein the valve plug is configured to translate a pressure differential within the valve body into a torque along the shaft. A buckling pin may be configured to engage with the shaft to receive the torque in the form of a first compressive load when the plug is in a closed position, and a pre-loading mechanism may be configured to pre-load the buckling pin with a second compressive load. Further, the buckling pin may be configured to fail when the combined first and second compressive loads reach a set load limit, and the valve plug may be configured to rotate into an open position when the buckling pin fails,

The disclosure also is directed to a rotatable pressure relief valve assembly, comprising a valve body defining a fluid flow path, and a valve plug having a rotational shaft, wherein the valve plug is configured to rotate along the rotational shaft between a closed position and an open position, and wherein the valve plug obstructs the fluid flow path when in the closed position. A tensile failure member may be configured to engage with the shaft to receive a rotational torque from the shaft in the form of a first tensile load when the plug is in the closed position. A pre-loading mechanism may be configured to pre-load the tensile failure member with a second tensile load. Further, the tensile failure member may be configured to fail when the combined first and second tensile loads reach a set load limit, and the valve plug may be configured to rotate into the open position when the tensile failure member fails.

Still further, the disclosure is directed to a rotatable pressure relief valve assembly, comprising a valve body defining a fluid flow path, the valve body having an inlet and an outlet. A valve plug disposed within the valve body may be configured to rotate about a shaft between a closed position and an open position, and may be configured to prevent fluid from flowing along the fluid flow path when in the closed position. The assembly may further comprise means for keeping the valve plug in the closed position until a set pressure differential between the valve body inlet and valve body outlet is reached and means for keeping the valve plug in the open position after the valve plug rotates into the open position.

Also disclosed is a rotatable pressure relief valve assembly, comprising a valve body defining a fluid flow path and having an inlet and an outlet. A valve plug may be disposed within the valve body, with the valve plug being configured to rotate about a shaft between a closed position and an open position, wherein the valve plug is configured to prevent fluid from flowing along the fluid flow path when in the closed position. The assembly may further comprise means for keeping the valve plug in the closed position until a set pressure differential between the valve body inlet and valve body outlet is reached, and means for absorbing a rotational kinetic energy imparted by the shaft when the valve plug rotates into the open position.

Further disclosed is a rotatable pressure relief valve assembly, comprising a valve body having an inlet and an outlet and defining a fluid flowpath, as well as a valve plug disposed within the valve body, wherein the plug is configured to rotate between a closed position and an open position, and wherein the plug is configured to block the fluid flowpath when oriented in the closed position. A release mechanism may be configured to hold the valve plug in the closed position until a set pressure differential across the inlet and outlet of the valve body is reached. A thermal shield may be positioned between the valve body and a heat source external to the valve body, and the thermal shield may be oriented to protect the valve body from asymmetric heating caused by the external heat source,

The disclosure also is directed to a rotatable pressure relief valve assembly, comprising a valve body and a valve plug disposed within the valve body. The valve plug may have a shaft defining an axis of rotation, and the valve plug may be configured to translate a pressure differential within the valve body into a torque along the shaft. The assembly may further comprise a buckling pin having a first end and a second end, as well as a pin mount. The first end of the buckling pin may be engaged with the shaft, and the second end of the buckling pin may be engaged with the pin mount. The buckling pin may be configured to receive the torque from the shaft as a compressive load when the plug is in a closed position. The buckling pin may be configured to fail when the compressive load reaches a set load limit, and the valve plug may be configured to rotate into an open position when the buckling pin fails.

Further, the disclosure is directed to a rotatable pressure relief valve assembly, comprising a valve body defining a fluid flow path and a valve plug having a rotational shaft, wherein the valve plug is configured to rotate along the rotational shaft between a closed position and an open position, and wherein the valve plug obstructs the fluid flow path when in the closed position. The assembly may further comprise a tensile failure member having a first end and a second end, along with a tensile failure member mount. The first end of the tensile failure member may be engaged with the shaft, and the second end of the tensile failure member may be engaged with the tensile failure member mount. The tensile failure member may be configured to receive a rotational torque from the shaft in the form of a tensile load when the plug is in the closed position. The tensile failure member may be configured to fail when the tensile load reaches a set load limit, and the valve plug may be configured to rotate into the open position when the tensile failure member fails.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 illustrates a view of the inlet side of a rotatable valve assembly.

FIG. 2 illustrates a cross-sectional view of the rotatable valve assembly illustrated in FIG. 1 taken along line A-A.

FIGS. 3A and 38 illustrate a side view of the release mechanism assembly of the rotatable valve assembly illustrated in FIG. 1.

FIG. 4 illustrates a rotatable valve assembly release mechanism including a latch and a spring energy absorber.

FIG. 5 illustrates a rotatable valve assembly release mechanism including a latch and a bellows energy absorber.

FIG. 6 illustrates a rotatable valve assembly release mechanism including a torsion spring configured to add an opening torque to the valve plug.

FIG. 7 illustrates a rotatable valve assembly release mechanism including a magnet configured to hold the plug in a fully-open orientation when the valve opens.

FIGS. 8A and 88 illustrate a side view of an energy absorbing mechanism for a rotatable valve plug assembly, wherein the energy absorbing mechanism is provided on the side opposite from the release mechanism.

FIGS. 9A and 9B illustrate a side view of a latching mechanism for a rotatable valve plug assembly, wherein the latching mechanism is provided on the side opposite from the release mechanism.

FIGS. 10A and 10B illustrate a cross-sectional view of a rotatable valve assembly including a wing-shaped valve plug.

FIG. 11A illustrates a rotatable valve assembly including a thermal shield attached to the valve assembly.

FIG. 11B illustrates a rotatable valve assembly including a thermal shield positioned between the valve assembly and a heat source,

FIG. 12 illustrates a rotatable valve plug including a cavity.

FIG. 13 illustrates a rotatable valve plug including a counterweight.

FIG. 14 illustrates a release mechanism for a rotatable valve assembly using a buckling pin.

FIG. 15 illustrates a release mechanism for a rotatable valve assembly using a tensile failure member.

FIG. 16 illustrates a partial view of the inlet side of a rotatable valve assembly with a shear pin.

FIG. 17 illustrates a side view of the rotatable valve assembly of FIG. 16.

FIG. 18 illustrates a detail view of a shear pin failure member installed as in the rotatable assembly illustrated in FIG. 16.

FIG. 19 illustrates a buckling pin engaged directly with a valve shaft of a of a rotatable valve assembly.

FIG. 20 illustrates a tensile failure member engaged directly with a valve shaft of a rotatable valve assembly.

FIG. 21 illustrates a notched shaft for use with a rotatable valve assembly.

FIGS. 22A-22B illustrate a latch for use with the notched shaft of FIG. 21.

FIGS. 23A-23B illustrate a housing a projection for use with the notched shaft of FIG. 21.

FIG. 24 illustrates a shaft having a toothed end.

### DESCRIPTION OF THE EMBODIMENTS

Reference will now be made in detail to the present exemplary embodiments, examples of which are illustrated in the accompanying drawings. Wherever possible, the same reference numbers will be used throughout the drawings to refer to the same or like parts. The drawing figures of this application are intended to provide a general understanding of the working elements of the underlying system. Accordingly, unless explicitly stated, the figures do not represent a literal depiction of proportional dimensions or the precise locations for the illustrated inter-related components.

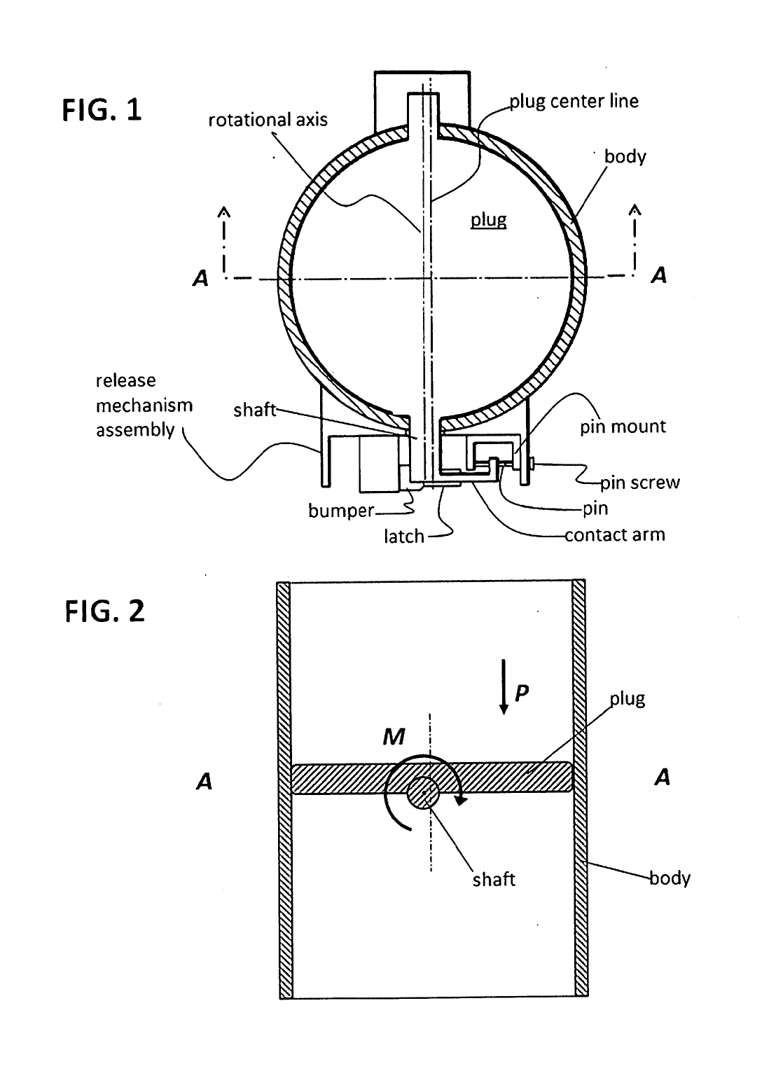

FIG. 1 illustrates one embodiment of a rotatable valve assembly of the present disclosure. The assembly includes a valve body and a valve plug. The valve plug is mounted in the valve body through a shaft defining a rotational axis. The body has an inlet and an outlet defining a fluid passageway through the body. The inlet of the body receives fluid and pressure from a fluid pressure source (not illustrated), such as a vessel or piping.

The shaft may extend through the body and may be rotatable with the plug, relative to the body, about the rotational axis. The shaft may be a single, continuous shaft extending across a face of or through the plug, or may be one or more shaft ends, axles, ears, or the like which extend from the plug through the body. A single continuous shaft may be desirable to increase rigidity and keep the shaft in alignment with the rotational axis. Limit switches, motion detection switches, or the like (not shown) may be provided at either or both outside ends of the shaft to indicate whether the plug is in the open or closed position and/or has been opened or closed.

As illustrated in FIG. 1, the valve plug may be mounted for eccentric rotation in the passageway. The rotational axis of the shaft and plug is offset from the diameter of the plug. As a result, the first portion of the plug on the first side of the rotational axis is larger and has greater area exposed to the inlet fluid pressure than the second portion of the plug on the second side of the rotational axis. This creates a moment and torque about the rotational axis and shaft. This arrangement has another advantage in that the shaft partially balances the fluid pressure on either side of the rotational axis and shaft and therefore reduces the pressure which the plug must directly resist to seal.

When valve plug is in a closed position, a pressure (P) in the pressurized system generates a torque and moment (M) (as shown in FIG. 2) on the valve plug about rotational axis. As illustrated in FIG. 1, the assembly may include a release mechanism configured to prevent the valve plug from rotating from the closed position when the torque about rotational axis is below a selected magnitude and for releasing the plug and shaft to rotate to an open position when the torque exerted around the rotational axis exceeds a selected magnitude.

In one embodiment, a release mechanism assembly is mounted on the valve body, as illustrated in FIGS. 1 and 2. The release mechanism may include a failure pin. As illustrated in FIG. 1, the failure pin may be mounted in the release mechanism assembly via a pin mount. The release mechanism also may include a contact arm, which translates the torque around the rotational axis into a load applied to the failure pin. The failure pin is configured to deform and/or fail under a predetermined load applied by the contact arm. The failure pin may be a permanently or irreversibly deformable structure, which bends or breaks when subjected to a predetermined load. Although a failure pin is illustrated, the disclosure contemplates the use of any suitable mechanism configured to deform and/or fail under a predetermined load, including but not limited to, a beam, bar, plate, disk, spring, or comparable structure (or any combination thereof). Such mechanisms may be permanently or irreversibly deformable. Alternatively, such mechanisms may be reversibly deformable, such that they return to an initial condition once a deforming load is removed. A failure pin (or other suitable mechanism) may be provided with features to facilitate failure or to establish a particular failure point, such as surface scoring or areas of reduced diameter.

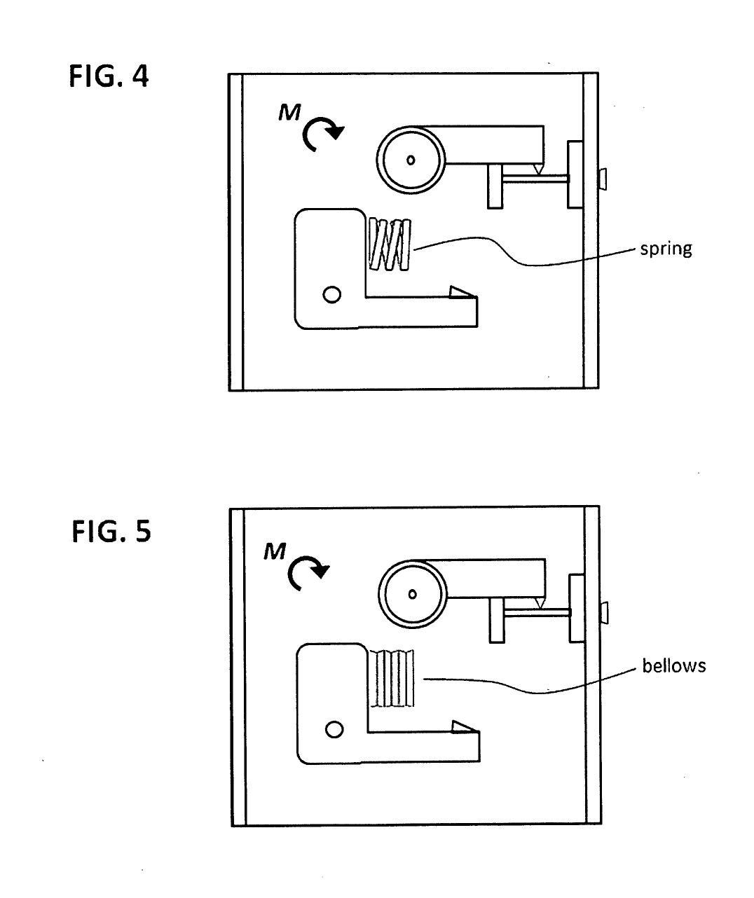

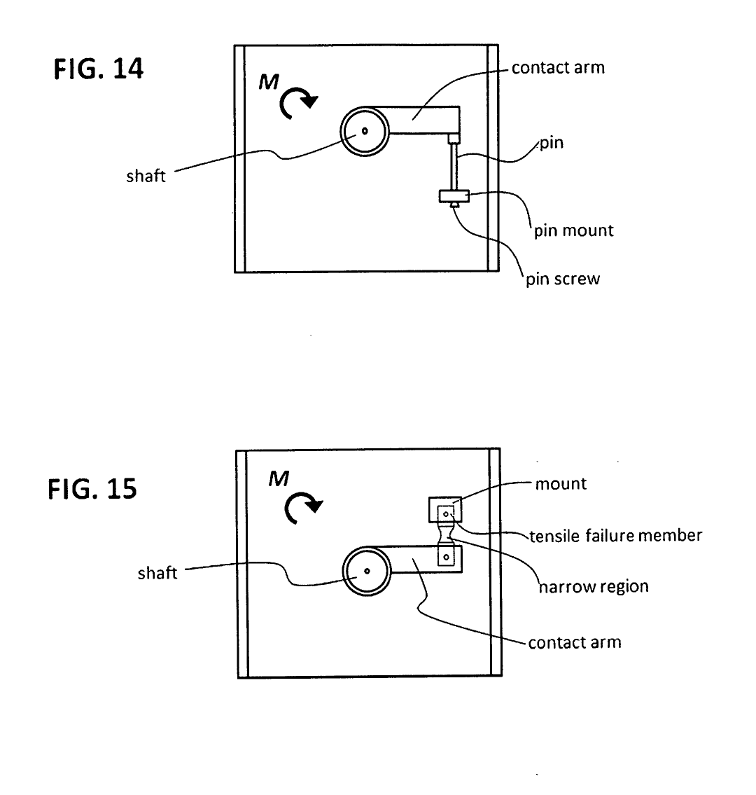

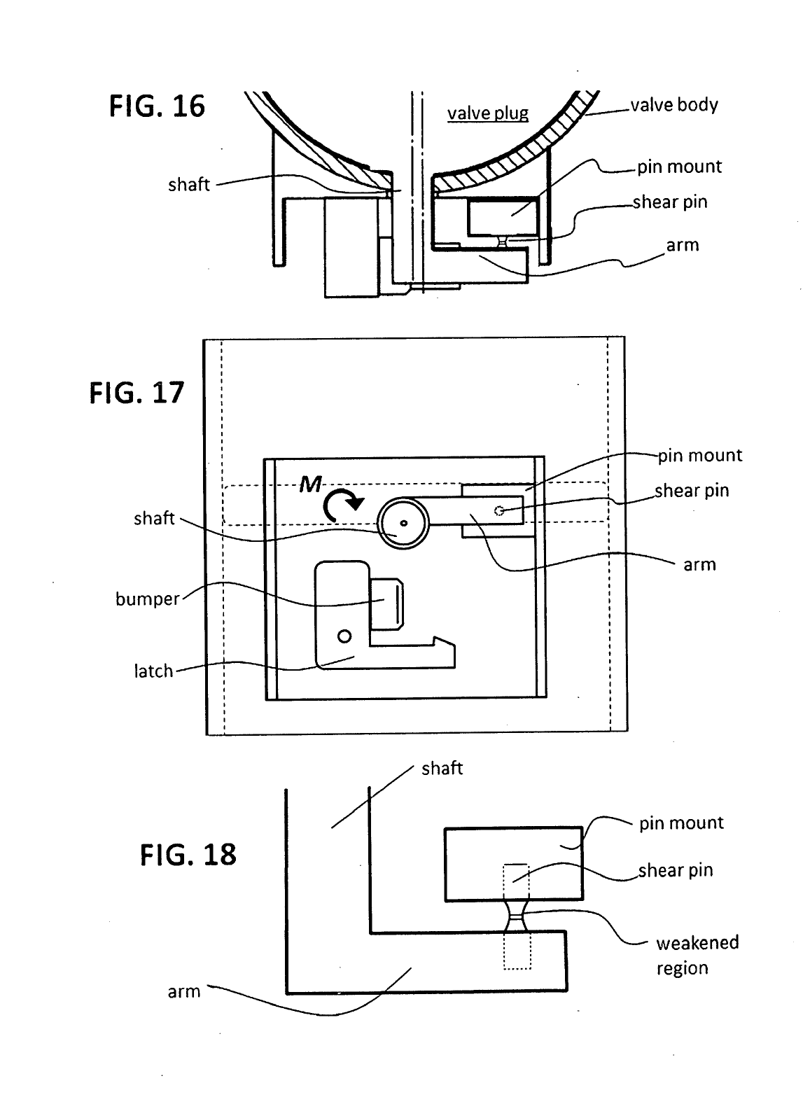

As illustrated in FIG. 1, the failure pin is subjected to a bending-type load applied by the contact arm. It is also contemplated that the failure pin (or other suitable failure mechanism) may be subject to a different type of loading, such as compression, tension, or shear, as illustrated in FIGS. 4-6 of U.S. Pat. No. 5,947,445 (the entire contents of which is incorporated herein by reference). For example, a compression-type buckling pin release mechanism is illustrated in FIG. 14. A release mechanism using a tensile failure member is illustrated in FIG. 15. As illustrated in FIG. 15, the tensile failure member is attached to one end of the contact arm and to a tensile failure member mount. A tensile failure member may be, e.g., a rod or a flat plate configured to fail when subjected to a predetermined tension. A tensile failure member may include a narrow region, such as illustrated in FIG. 15, configured to set the tension at which the failure member will fail. As another example, FIGS. 16-18 illustrate an embodiment of a rotatable valve assembly using a shear pin. As illustrated in FIGS. 16 and 18, a rotational shaft extends from a valve plug, and an arm extends from the shaft. A shear pin is positioned between the arm and a pin mount, preventing the arm (and shaft) from rotating. As illustrated in FIG. 16, the shear pin may be provided with a narrowed weakened region, to facilitate shear and set the value of shear at which the shear pin may fail.

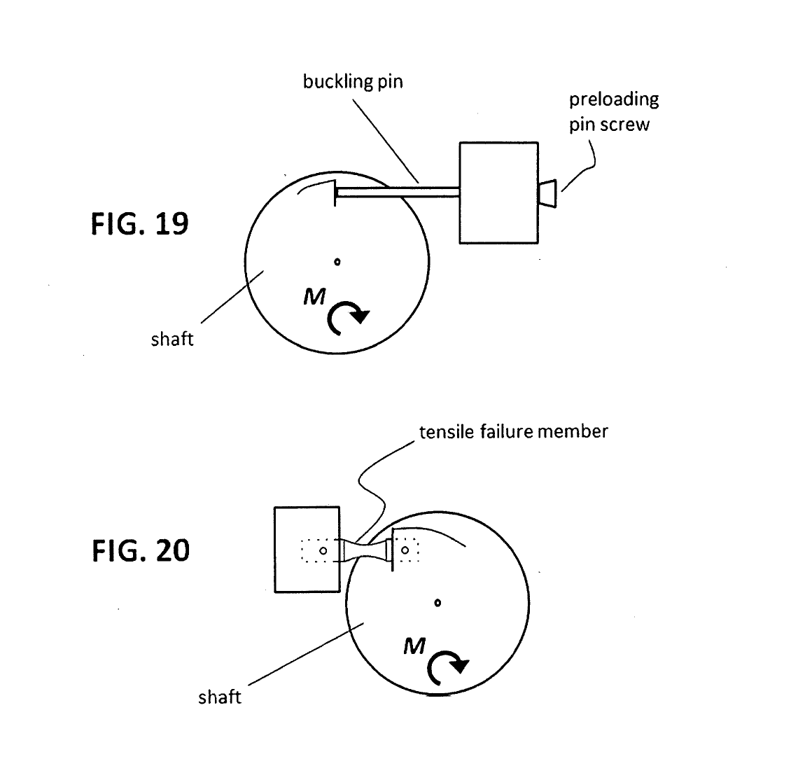

Although FIG. 1 and FIGS. 14-18 illustrate a contact arm extending from the shaft to engage a failure mechanism, the disclosure is not limited to such an arrangement. In one embodiment, a failure mechanism may be engaged directly with the rotating shaft. For example, a pin may be inserted through the shaft and engaged with the valve body, subjecting the pin to a shear load, as illustrated in FIG. 1 of co-owned U.S. Pat. No. 5,984,269, the entire contents of which is hereby incorporated by reference. As another example, illustrated in FIG. 19, a compression-type buckling pin may engage directly with a portion of the valve shaft, so that the buckling pin will oppose rotation of the valve shaft. When the buckling pin of FIG. 19 is subject to a predetermined load, it may fail and allow the shaft to rotate. As illustrated in FIG. 19, a pin screw may be provided to pre-load the buckling pin. In another embodiment, a buckling pin may be pre-loaded using another preloading mechanism, such as a spring, or may be preloaded within a pin cartridge. As yet another example, illustrated in FIG. 20, a tensile failure member (e.g., a tensile rod, or a tensile plate) may engage directly with a portion of the valve shaft, so that the tensile failure member will oppose rotation of the valve shaft. When the tensile failure member is subject to a predetermined load, it may fail in tension and allow the shaft to rotate.

FIG. 1 illustrates a pin screw that may be used to pre-load the failure pin. FIG. 14 illustrates another embodiment of a pin screw, which may be used to pre-load a compression-type buckling pin. Pre-loading a failure member also may be achieved using a clamp, spring, or any other suitable pre-loading mechanism. Pre-loading may increase the predictability of the valve plug's performance. Pre loading may add to the opening torque, which may help the valve open more quickly. Pre-loading may, for example, be used to overcome static friction in valve seals and mechanical linkages, and reduce the impact of those factors on the opening pressure of the valve.

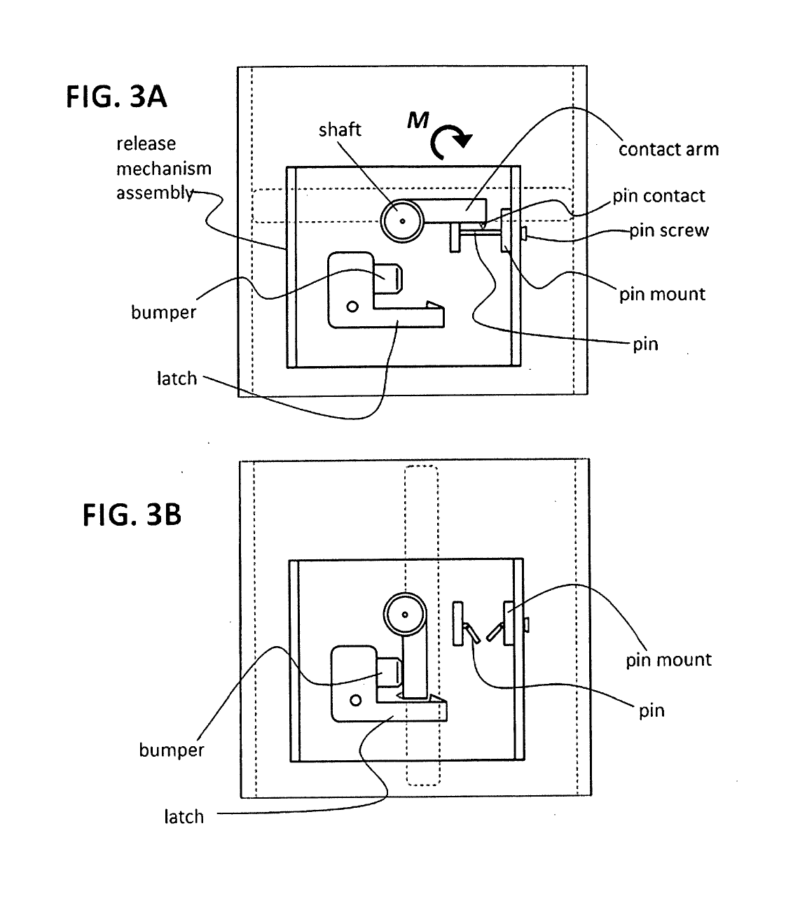

FIGS. 3A and 3B illustrate a side view of the release mechanism assembly of the rotatable valve assembly of FIG. 1. As illustrated, the contact arm includes a pin contact element placed into contact with the failure pin. The release mechanism assembly includes a latch and a bumper. The bumper is configured to absorb rotational energy of the plug (via the contact arm) when the valve plug opens after the failure pin breaks (as shown in FIG. 3B). The latch is configured to hold the plug in a fully-open position when the valve has opened. Although a latch and a bumper are illustrated together in FIGS. 3B, it is contemplated that a latch may be provided without a bumper or other energy-absorbing mechanism. It also is contemplated that a bumper or other energy-absorbing mechanism may be provided without the use of a latch.

Although a bumper is illustrated in FIGS. 3A and 3B, it is contemplated that any suitable damper or energy-absorbing mechanism may be used to absorb the rotational energy of an opening valve plug. For example, in FIG. 4, a spring is provided. As another example, in FIG. 5, a collapsible bellows is provided. A suitable energy-absorbing mechanism may be configured to deform (reversibly or irreversibly). Other examples of suitable energy absorbing mechanisms may include Belleville washers, Belleville springs, hydraulic pistons, or pads. The energy absorbing mechanism may be provided as part of a module or cartridge that may be replaceable.

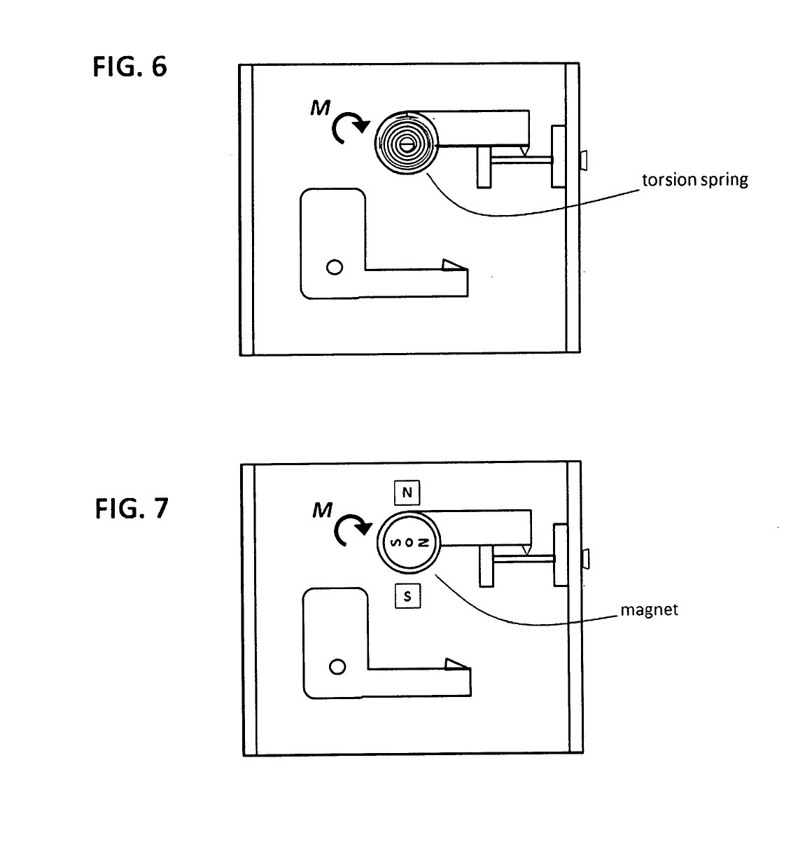

Although a latch is illustrated in FIGS. 3A and 3B, it is contemplated that any suitable catching mechanism may be used (in addition to or as an alternative to a latch) to hold a valve plug in an open position after opening. For example, in FIG. 6, a torsion spring is provided. The torsion spring in FIG. 6 is configured to apply an opening torque on the valve plug. As another example, in FIG. 7, a magnet is provided to exert a magnetic force tending to hold the valve plug in an open position after opening. Other examples of suitable mechanisms to hold a valve plug in an open position may include clips, hook-and-loop closures, or adhesives.

The torsion spring illustrated in FIG. 6 also may pre-load a force on the failure pin. Pre-loading may add to the opening torque, which may help the valve open more quickly. Pre-loading may, for example, be used to overcome static friction in valve seals and mechanical linkages, and reduce the impact of those factors on the opening pressure of the valve.

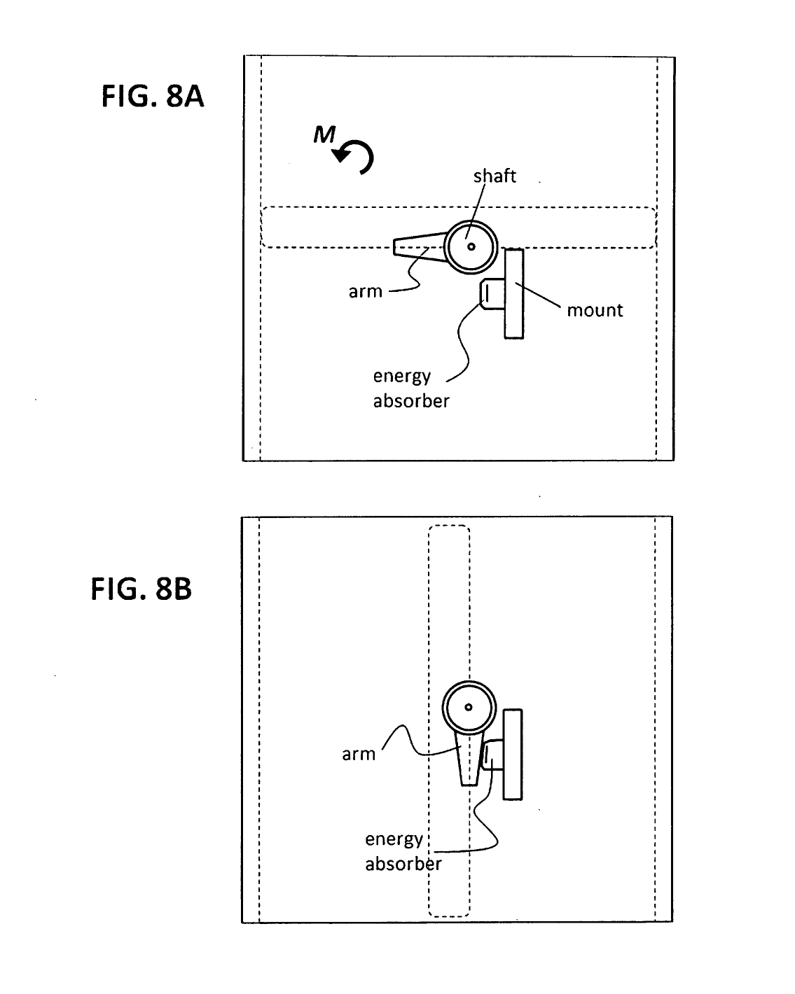

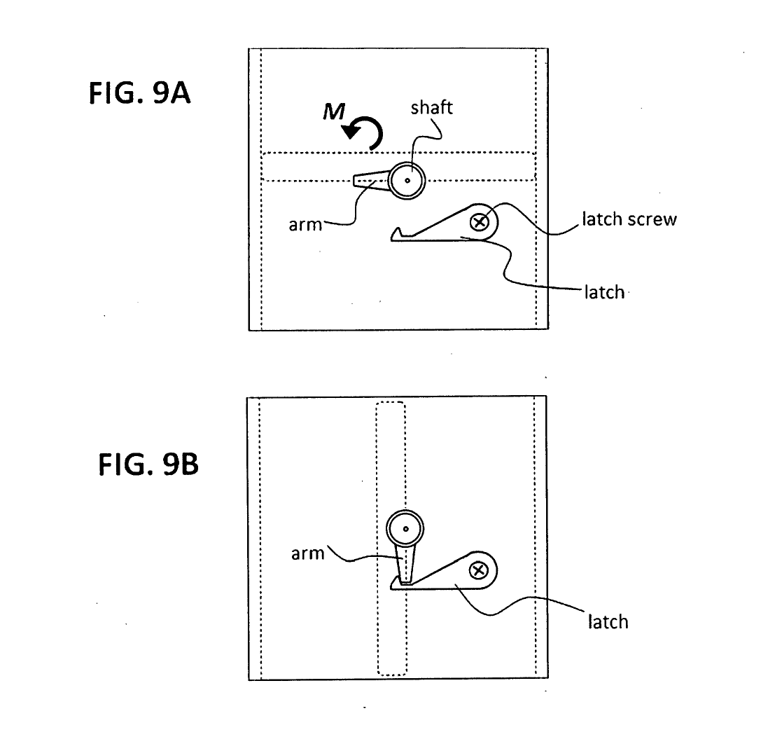

The energy-absorbing and latch features illustrated, for example, in FIGS. 1-3B are positioned on the same side of the valve body as the release mechanism. The present disclosure is not limited to that configuration. For example, as shown in FIGS. 8A and 8B, an energy absorber may be mounted on the opposite side of the valve body from the release mechanism. As shown in FIG. 8A, the valve shaft may be provided with an arm, which is brought into contact with the energy absorber when the valve plug opens (FIG. 8B). As another example, as shown in FIGS. 9A and 9B, a latch may be mounted on the opposite side of the valve body from the release mechanism. The latch may be configured to catch an arm extending from the valve plug shaft when the valve plug opens (FIG. 9B). The latch illustrated in FIGS. 9A and 9B is provided with a latch screw that may be used to tighten or loosen the latch, thereby increasing or decreasing the force that must be applied to activate the latch. It is contemplated that increasing the force that must be applied to activate the latch may allow the latch to absorb rotational energy from the opening valve plug.

FIGS. 8A, 8B, 9A, and 9B illustrate an arm extending from the valve shaft to engage with an energy absorber and/or catching mechanism. It is contemplated, however, that an arm need not be used. For example, the shaft may engage directly with an energy absorber, a catching mechanism, a mechanism to slow or stop the shaft's rotation, or other aspect(s) of the present disclosure.

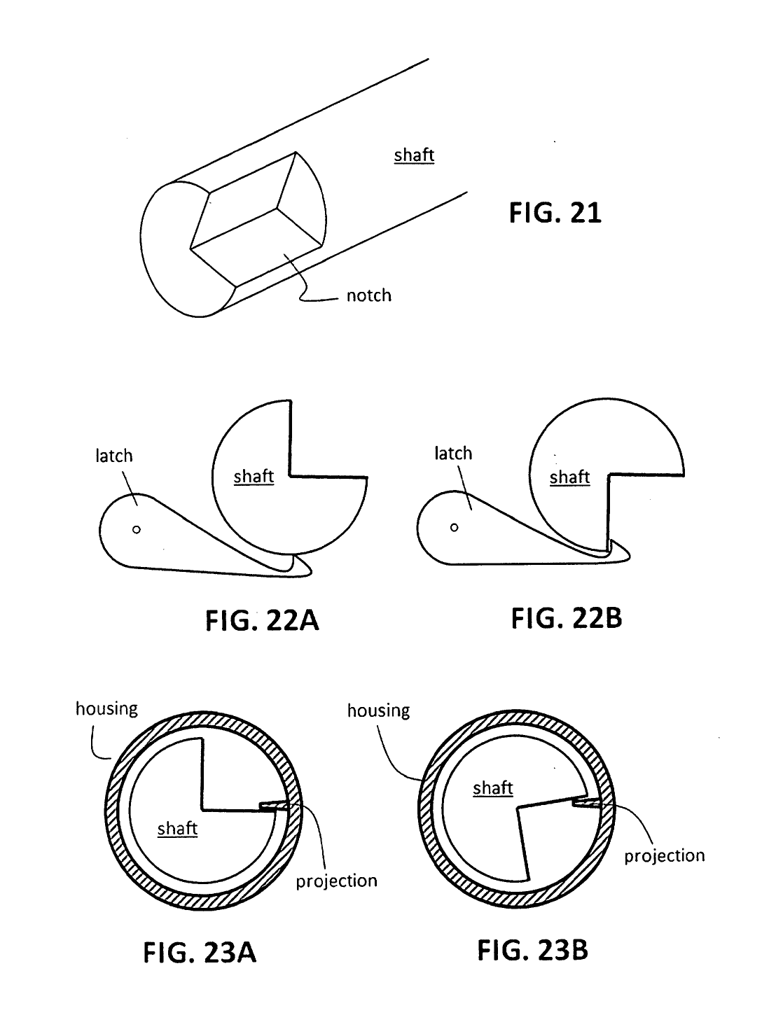

In one embodiment, the shaft may include a notch or other geometry configured to operate with another mechanism to limit the shafts rotation relative to the valve body. For example, as illustrated in FIG. 21, the shaft may include a notch. In a rotational valve assembly, the notched shaft of FIG. 21 may be used in conjunction with a catching mechanism, such as the latch illustrated in FIGS. 22A and 22B. As shown in FIG. 22A, the shaft is in a closed-valve position, and the latch is disengaged. As shown in FIG. 22B, the shaft has rotated clockwise 90 degrees into an open position, allowing the latch to engage with the notch in the shaft and prevent the shaft from rotating back toward a valve-closed position.

In another embodiment, the notched end of a shaft may fit within a shaft housing (illustrated in FIGS. 23A and 23B) that may extend from or otherwise be attached to the valve body. The shaft housing may include a projection or other feature configured to stop the shaft from rotating beyond a set position (e.g., a position corresponding to the substantially open position of the valve plug). By way of illustration, FIG. 23A illustrates the notched shaft of FIG. 21 in a valve-closed position, and FIG. 23B illustrates the notched shaft of FIG. 21 in a valve-open position, wherein the projection of the shaft housing has prevented the shaft from further rotation. The projection of the shaft housing may be configured to absorb a rotational energy from the shaft and/or may include features to catch the shaft to prevent it from further rotation.

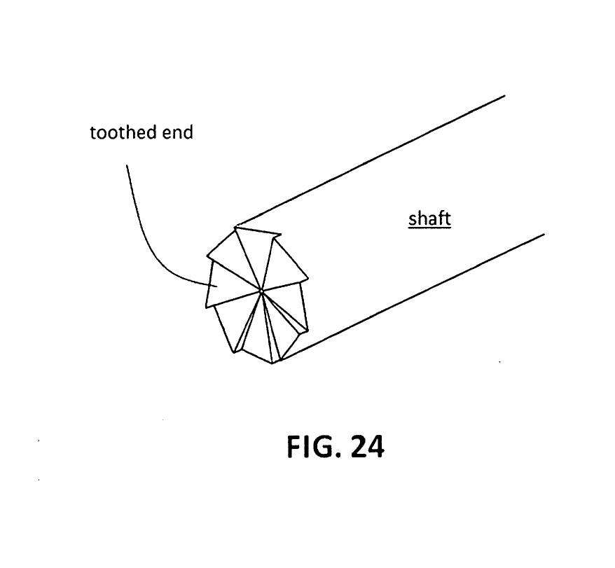

It is also contemplated that a shaft may be configured to cooperate with a catching mechanism that may include a clutch mechanism or a ratcheting mechanism. As illustrated in FIG. 24, for example, a shaft may include a toothed end. When paired with a ratchet or clutch (not shown), the shaft illustrated in FIG. 24 may be allowed to rotate in only one direction. As a result, the shaft may be prevented from returning a valve plug to a closed position after opening

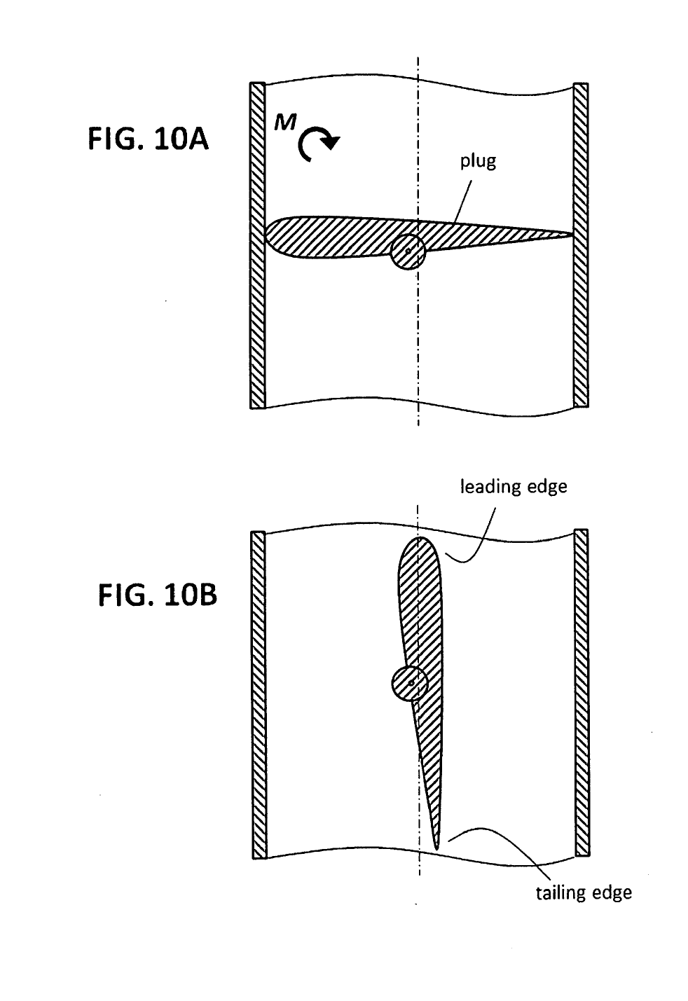

The valve plug of a rotatable valve assembly may be shaped to improve fluid flow characteristics upon opening of the valve. As illustrated in FIGS. 10A and 10B, for example, a valve plug may be provided with a wing-shaped or rudder-shaped cross-section. The illustrated valve plug includes a smoothly curved leading edge, and tapers toward the tailing edge. When the wing-shaped or rudder-shaped valve plug is in the open position (FIG. 10B), fluid may flow around the valve plug more smoothly than it would around a typical valve plug (which typically presents an abrupt profile to the fluid flow and lacks a tapering feature). As compared to a known valve plug, the resulting smooth flow may reduce turbulence and/or increase the rate at which an escaping fluid may flow. In addition, the fluid flow around a wing-shaped or rudder-shaped valve plug may add to the rotational force to open the valve more quickly. Also, the fluid flow around a wing-shaped or rudder-shaped valve plug may hold the valve plug in an open position, slow down rotation of the plug as the fully-open orientation is approached, and/or prevent the plug from oscillating between open and closed positions. Accordingly, the present disclosure contemplates that modifying the valve plug profile may eliminate the need for (or add to the effectiveness of) a latching mechanism or energy-absorbing mechanism such as those illustrated in FIGS. 1-3, In other words, a wing-shaped or rudder-shaped valve plug may be used with or without a latch and/or an energy-absorbing mechanism.

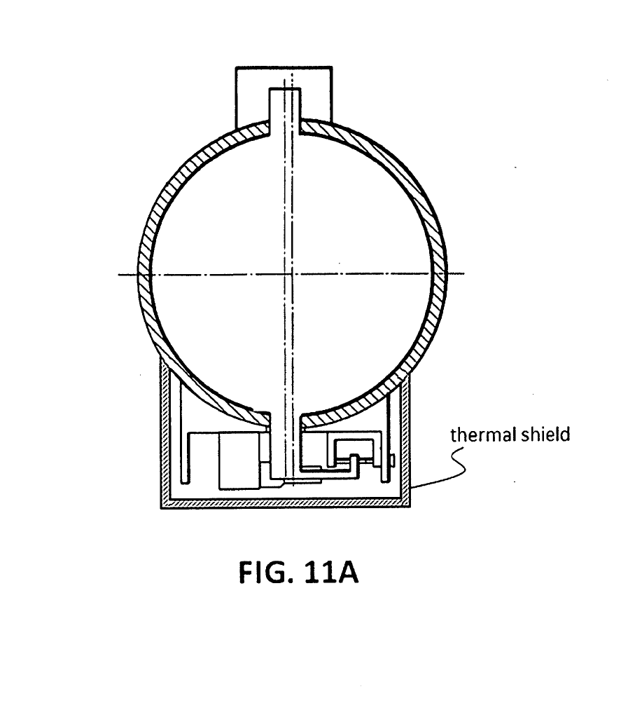

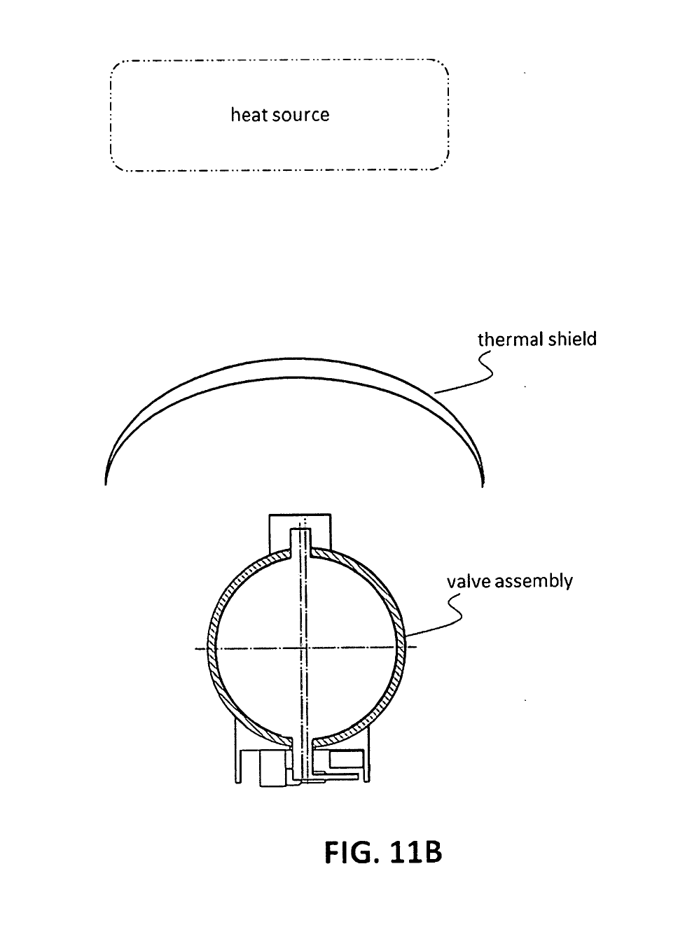

A rotatable valve assembly may include components that are susceptible to warping or damage from environmental heat. Accordingly, a thermal shield may be used to protect the rotatable valve assembly or its components from environmental heat. As illustrated in FIG. 11A, for example, the release mechanism assembly of a rotatable valve assembly may be surrounded with a thermal shield. In addition or alternatively, a thermal shield may be provided around part or all of the valve body. In one embodiment, a thermal shield may be attached to the valve body. In another embodiment, illustrated in FIG. 11B, a thermal shield may be positioned proximate to the valve body between the valve body and a heat source. The thermal shield in FIG. 11B may be, for example, a reflective sail to reflect away radiant heat. Any other mechanism suitable to reflect, insulate, or otherwise protect a valve from a heat source also is contemplated. A thermal shield may be particularly desirable to prevent non-symrnetrical heating of a valve, because non-symmetrical heating may generate distortion in the body-shaft relationship that may interfere with valve operation.

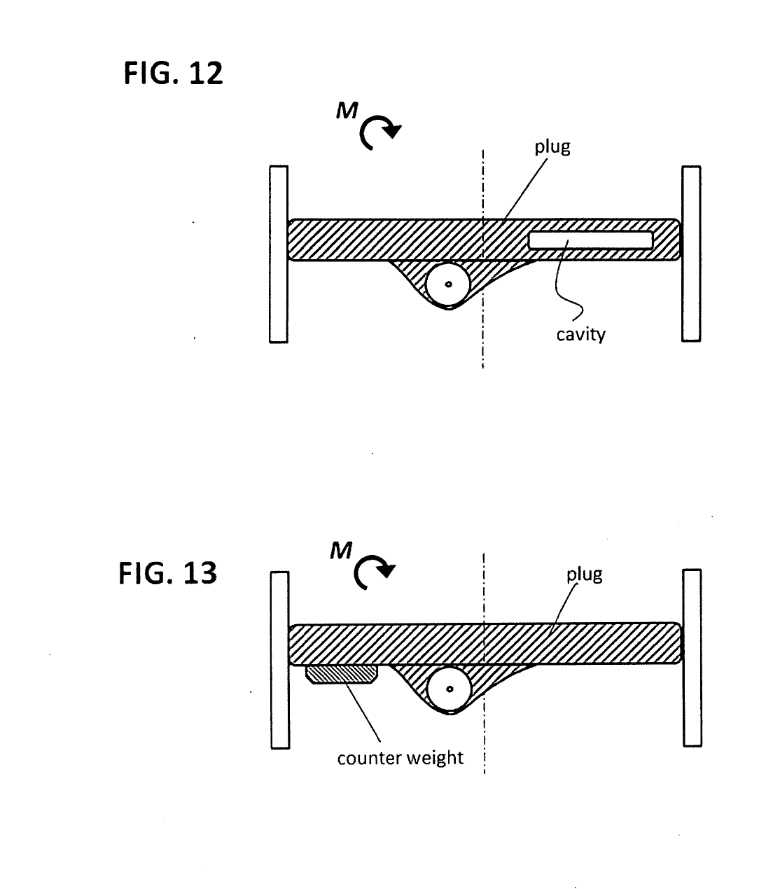

As a result of the offset shaft design used with a known rotatable valve plug, the mass of a known plug may be unevenly distributed across the rotatable shaft. The present disclosure contemplates a providing a weight-balanced or gravity-neutral plug with an offset shaft. For example, as illustrated in FIG. 12, a portion of the valve plug may include a cavity to reduce the mass on one side of the shaft. As another example, shown in FIG. 13, the valve plug may be provided with a counterweight to add to the mass on one side of the shaft. It is also contemplated that shaping the valve plug to be thicker on one side of the shaft (e.g., in the wing shaped design illustrated in FIGS. 10A and 10B) also may balance the weight of the valve plug relative to the shaft.

Although at least a portion of the foregoing disclosure focuses on a rotatable valve plug assembly having one release mechanism positioned at one end of a valve shaft, the disclosure is not limited to such an arrangement. Principles of the disclosure may be used with a rotatable valve plug assembly having multiple release mechanisms. For example, a pair of mated release mechanisms may be provided, with one release mechanism on each end of a valve shaft. Such an arrangement may result in a more even load on the valve plug and valve shaft when placed under pressure e.g., such an arrangement may reduce a torsion applied to the valve shaft. Principles of the disclosure may be used to provide, e.g., a latch and/or energy absorber on one or both ends of the shaft (i.e., with one or both of the release mechanisms).

The foregoing embodiments are exemplary only. Other embodiments will be apparent to those skilled in the art from consideration of the specification and practice of the disclosure herein.

What is claimed is:

1. A rotatable pressure relief valve assembly, comprising:
a valve body;
a plug mounted within the body, the plug being rotatable between an open position and a closed position about a rotatable shaft;
a release mechanism configured to engage with the shaft and hold the plug in a closed position until an opening pressure of the valve assembly is reached; and,
a damper configured to absorb a rotational kinetic energy imparted by the shaft when the valve plug rotates into the open position.

2. The rotatable pressure relief valve assembly of claim 1, wherein the rotatable shaft comprises a contact arm;
wherein the release mechanism is configured to engage with the shaft via the contact arm; and
wherein the contact arm is configured to transmit a torque from the shaft to the release mechanism.

3. The rotatable pressure relief valve assembly of claim 1, wherein the rotatable shaft comprises a contact arm; and
wherein the damper is configured to absorb the rotational kinetic energy by engaging with the contact arm.

4. The rotatable pressure relief valve assembly of claim 1, wherein the rotatable shaft comprises a notch; and
wherein the damper is positioned within the notch of the rotatable shaft.

5. The rotatable pressure relief valve assembly of claim 1, wherein the rotatable shaft comprises at least one tooth; and
wherein the damper is configured to absorb the rotational kinetic energy by engaging with the at least one tooth.

6. The rotatable pressure relief valve assembly of claim 1, wherein the release mechanism comprises a failure member, the assembly further comprising a pre-loading mechanism configured to pre-load the failure member.

7. The rotatable pressure relief valve assembly of claim 1, further comprising a thermal shield.

8. The rotatable pressure relief valve assembly of claim 7, wherein the thermal shield is attached to the valve body.

9. The rotatable pressure relief valve assembly of claim 1, wherein the shaft is offset from a diameter of the valve plug, and wherein the mass of the plug is distributed evenly on either side of the offset shaft.

10. The rotatable pressure relief valve assembly of claim 1, wherein the shaft has a first end and a second end;
wherein the release mechanism is configured to engage with the first end of the shaft: and
wherein the damper is configured to engage with the second end of the shaft.

11. A rotatable pressure relief valve assembly, comprising:
a valve body;
a plug mounted within the body, the plug being rotatable between an open position and a closed position about a rotatable shaft
a release mechanism configured to engage with the shaft and hold the plug in a closed position until an opening pressure of the valve assembly is reached; and,
a catching mechanism configured to engage shaft when the valve plug rotates into the open position, wherein the catching mechanism is further configured to retain the plug in the open position,

12. The rotatable pressure relief valve assembly of claim 11, wherein the shaft comprises a contact arm; and
wherein catching mechanism is a latch, and wherein the latch is configured to engage the shaft via the contact arm.

13. The rotatable pressure relief valve assembly of claim 11, wherein the release mechanism comprises a failure member, the assembly further comprising:
a pre-loading mechanism configured to pre-load the failure member,

14. The rotatable pressure relief valve assembly of claim 11, wherein the catching mechanism comprises a clutch.

15. The rotatable pressure relief valve assembly of claim 11, wherein the catching mechanism comprises a ratchet.

16. The rotatable pressure relief valve assembly of claim 11, wherein the shaft comprises a notch; and
wherein the catching mechanism is configured to engage with the notch when the valve plug rotates into the open position.

17. The rotatable pressure relief valve assembly of claim 11, wherein the shaft comprises at least one tooth; and
wherein the catching mechanism is configured to engage with the at least one tooth when the valve plug rotates into the open position,

18. The rotatable pressure relief valve assembly of claim 11, further comprising:
a thermal shield.

19. The rotatable pressure relief valve assembly of claim 11, wherein the shaft is offset from a diameter of the valve plug, and wherein the mass of the plug is distributed evenly on either side of the offset shaft.

20. The rotatable pressure relief valve assembly of claim 1, wherein the shaft has a first end and a second end;
wherein the release mechanism is configured to engage with the first end of the shaft; and
wherein the catching mechanism is configured to engage with the second end of the shaft.

21. A rotatable pressure relief valve assembly, comprising
a valve body;
a plug mounted within the body, the plug being rotatable between an open position and a closed position about a rotatable shaft;
wherein the plug is wing-shaped.

22. A rotatable pressure relief valve assembly, comprising:
a valve body;
a valve shaft,
a plug engaged with the valve shaft and disposed within the valve body, wherein the plug has a diameter parallel to the shaft, and wherein the diameter is offset from the shaft;
wherein the mass of the plug is balanced across the shaft.

23. A rotatable pressure relief valve assembly, comprising:
a valve body;
a valve plug disposed within the valve body, the valve plug having a shaft defining an axis of rotation, wherein the valve plug is configured to translate a pressure differential within the valve body into a torque along the shaft, and
a buckling pin configured to engage with the shaft to receive the torque in the form of a first compressive load when the plug is in a closed position; and
a pre-loading mechanism configured to pre-load the buckling pin with a second compressive load;
wherein the buckling pin is configured to fail when the combined first and second compressive loads reach a set load limit, and wherein the valve plug is configured to rotate into an open position when the buckling pin fails.

24. The rotatable pressure relief valve assembly of claim 23, further comprising:
a catching mechanism configured to engage the shaft when the plug rotates into the open position and thereby prevent the shaft from rotating further.

25. The rotatable pressure relief valve assembly of claim 23, further comprising:
an energy absorber configured to engage the shaft when the plug rotates into the open position and thereby absorb a Kinetic rotational energy imparted by the shaft.

26. A rotatable pressure relief valve assembly, comprising:
a valve body defining a fluid flow path;
a valve plug having a rotational shaft, wherein the valve plug is configured to rotate along the rotational shaft between a closed position and an open position, wherein the valve plug obstructs the fluid flow path when in the closed position;
a tensile failure member configured to engage with the shaft to receive a rotational torque from the shaft in the form of a first tensile load when the plug is in the closed position; and
a pre-loading mechanism configured to pre-load the tensile failure member with a second tensile load;
wherein the tensile failure member is configured to fail when the combined first and second tensile loads reach a set load limit, and wherein the valve plug is configured to rotate into the open position when the tensile failure member fails.

27. The rotatable pressure relief valve assembly of claim 26, further comprising:
a catching mechanism configured to engage the shaft when the plug rotates into the open position and thereby prevent the shaft from rotating further.

28. The rotatable pressure relief valve assembly of claim 26, further comprising:
an energy absorber configured to engage the shaft when the plug rotates into the open position and thereby absorb a kinetic rotational energy imparted by the shaft.

29. A rotatable pressure relief valve assembly, comprising:
a valve body defining a fluid flow path, the valve body having an inlet and an outlet;
a valve plug disposed within the valve body, the valve plug being configured to rotate about a shaft between a closed position and an open position, wherein the valve plug is configured to prevent fluid from flowing along the fluid flow path when in the closed position;
means for keeping the valve plug in the closed position until a set pressure differential between the valve body inlet and valve body outlet is reached; and,
means for keeping the valve plug in the open position after the valve plug rotates into the open position.

30. A rotatable pressure relief valve assembly, comprising:
a valve body defining a fluid flow path, the valve body having an inlet and an outlet;
a valve plug disposed within the valve body, the valve plug being configured to rotate about a shaft between a closed position and an open position, wherein the valve plug is configured to prevent fluid from flowing along the fluid flow path when in the closed position;
means for keeping the valve plug in the closed position until a set pressure differential between the valve body inlet and valve body outlet is reached; and,
means for absorbing a rotational kinetic energy imparted by the shaft when the valve plug rotates into the open position.

31. A rotatable pressure relief valve assembly, comprising:
a valve body having an inlet and an outlet and defining a fluid flowpath;
a valve plug disposed within the valve body, wherein the plug is configured to rotate between a closed position and an open position, and wherein the plug is configured to block the fluid flowpath when oriented in the closed position;
a release mechanism configured to hold the valve plug in the closed position until a set pressure differential across the inlet and outlet of the valve body is reached; and
a thermal shield positioned between the valve body and a heat source external to the valve body, wherein the thermal shield is oriented to protect the valve body from asymmetric heating caused by the external heat source.

32. A rotatable pressure relief valve assembly, comprising:
a valve body;
a valve plug disposed within the valve body, the valve plug having a shaft defining an axis of rotation, wherein the valve plug is configured to translate a pressure differential within the valve body into a torque along the shaft, and
a buckling pin having a first end and a second end; and
a pin mount;
wherein the first end of the buckling pin is engaged with the shaft, and wherein the second end of the buckling pin is engaged with the pin mount;
wherein the buckling pin is configured to receive the torque from the shaft as a compressive load when the plug is in a closed position; and
wherein the buckling pin is configured to fail when the compressive load reaches a set load limit, and wherein the valve plug is configured to rotate into an open position when the buckling pin fails.

33. A rotatable pressure relief valve assembly, comprising:
a valve body defining a fluid flow path:
a valve plug having a rotational shaft, wherein the valve plug is configured to rotate along the rotational shaft between a closed position and an open position, wherein the valve plug obstructs the fluid flow path when in the closed position;
a tensile failure member having a first end and a second end; and
a tensile failure member mount;
wherein the first end of the tensile failure member is engaged with the shaft, and wherein the second end of the tensile failure member is engaged with the tensile failure member mount;
wherein the tensile failure member is configured to receive a rotational torque from the shaft in the form of a tensile load when the plug is in the closed position; and
wherein the tensile failure member is configured to fail when the tensile load reaches a set load limit, and wherein the valve plug is configured to rotate into the open position when the tensile failure member falls.
